(19) United States
(12) Patent Application Publication
(10) Pub. No.: US 2018/0114242 A1
(43) Pub. Date: Apr. 26, 2018

(54) Deal recommendation based on triggering event

(71) Applicant: Amazon Technologies, Inc., Reno, NV (US)

(72) Inventors: Gustavo Eduardo Lopez, Seattle, WA (US); Siddharth Arora, Seattle, WA (US); Maciej Golonka, Sammamish, WA (US)

(73) Assignee: Amazon Technologies, Inc., Reno, NV (US)

(21) Appl. No.: 14/192,420

(22) Filed: Feb. 27, 2014

(51) Int. Cl. G06Q 30/02

(52) U.S. Cl. CPC G06Q 30/0224

(57) ABSTRACT

The systems and processes discussed herein may identify, prioritize, and recommend new deals to consumers based at least in part on triggering events. A consumer may interact with a previously acquired deal, such as by redeeming the deal, requesting a refund for the deal, etc. Such user interaction may be determined to be a triggering event. Based on a type of the triggering event, the systems described herein may identify one or more new deals having characteristics similar to the previously acquired deal. The one or more new deals may be recommended to a user at the same time or at some time after the triggering event occurs via a website, an e-mail message, an application associated with a user device, a text message, or any other manner that may be used to communicate the new deals to the user.

### BACKGROUND

In addition to offering items (e.g., products, services, etc.) for sale via a brick-and-mortar store or a merchant-branded website, merchants frequently make those items available via different channels. For instance, a service provider may offer items for sale on behalf of multiple merchants via a merchant marketplace that is accessible by consumers. Utilizing the merchant marketplace, the service provider may also offer deals that promote or feature merchants and/or merchant items. Generally, service providers have a limited number of opportunities to recommend a deal to a customer. Therefore, service providers may prioritize deals such that more relevant deals are provided to a customer before less relevant deals. Due to the large number of merchants participating in the merchant marketplace and the resulting influx of deals available for user selection, it may be difficult, resource-intensive, inefficient, etc., to provide the most relevant deals to consumers. In addition, not providing the most relevant deals to consumers may result in a poor customer experience, which may result in lost revenue and profits.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 illustrates an example system for recommending deals provided by a service provider on behalf of merchants based on triggering events.

FIG. 2 is a diagram showing an example system for utilizing one or more types of data to generate recommendations for deals based on triggering events.

FIG. 3 is a flow diagram illustrating an example process of recommending new deals to consumers based on triggering events.

FIG. 4 is a flow diagram illustrating an example process of recommending new deals to consumers based on a redemption of a previously acquired deal.

FIG. 5 is a flow diagram illustrating an example process of recommending new deals to consumers based on user feedback.

FIG. 6 is a flow diagram illustrating an example process of recommending new deals to consumers based on a refund request of a previously acquired deal.

FIG. 7 is a flow diagram illustrating an example process of recommending new deals to consumers based on an expiration of a previously acquired deal.

FIG. 8 is a flow diagram illustrating an example process of recommending new deals to consumers based on an identified gap in a user's portfolio of previously acquired deals.

FIG. 9 is a flow diagram illustrating an example process of recommending new deals to consumers based on an indication of a user's geographic location.

### DETAILED DESCRIPTION

This disclosure describes systems and processes for optimizing the recommendation of new deals to consumers by basing the recommendations at least in part on triggering events. More particularly, a service provider may recommend or offer a new deal for acquisition that may promote or feature items (e.g., products, services, etc.) provided by a merchant based in part on a consumer's interaction with a previously acquired deal, user feedback, and/or geographic location information. For instance, a consumer may acquire a deal for a merchant's products or services as promoted or featured by the service provider. At a subsequent time, the consumer may interact with the previously acquired deal, such as by redeeming the deal, requesting a refund for the deal, etc. Based on a type of interaction (e.g., redemption, refund request, etc.), the service provider may identify one or more new deals in the service provider's inventory having characteristics similar to the previously acquired deal (e.g., merchants, products, services, etc.) and may prioritize or de-prioritize new deals of the one or more new deals based at least in part on the type of user interaction.

In at least one embodiment, a user may redeem a previously acquired deal. The service provider may determine the redemption to be a triggering event. Furthermore, the service provider may identify relevant characteristics of the redeemed deal. Relevant characteristics of the redeemed deal include merchant(s) associated with products and/or services featured in the deals. Additionally, relevant characteristics may include categories of products and/or services associated with the deals and subcategories of products and/or services associated with the deals. Categories of products and/or services associated with the deals may be arbitrarily subdivided to create various numbers and/or levels of subcategories. Other relevant characteristics may include geographic locations associated with the deals, the merchant(s) or prices paid for the previously acquired deals, etc. Based on the relevant characteristics, the service provider may identify new deals in the service provider's inventory that have at least some characteristics similar to those of the redeemed deal. Then, the service provider may recommend one or more of the new deals to a user when the user redeems the previously acquired deal. In alternative embodiments, the one or more new deals may be recommended at a time subsequent to the redemption.

In additional or alternative embodiments, a user may request a refund for a previously acquired deal, or a previously acquired deal may expire, possibly unbeknownst to the user. The service provider may determine the request for the refund or the expiration to be triggering events. Other triggering events may include receiving user feedback and/or indications of a user's geographic location. Based on a type of triggering event and relevant characteristics of the previously acquired deal, the service provider may recommend one or more new deals to a user at the same time the triggering event occurs. In alternative embodiments, the service provider may recommend the one or more new deals at some time after the triggering event occurs.

Accordingly, the systems and/or processes described herein allow for recommending new deals to consumers based in part on triggering events. Using triggering events to identify new deals for recommendation may allow service providers to more precisely target consumers and maximize opportunities for repeat purchases.

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

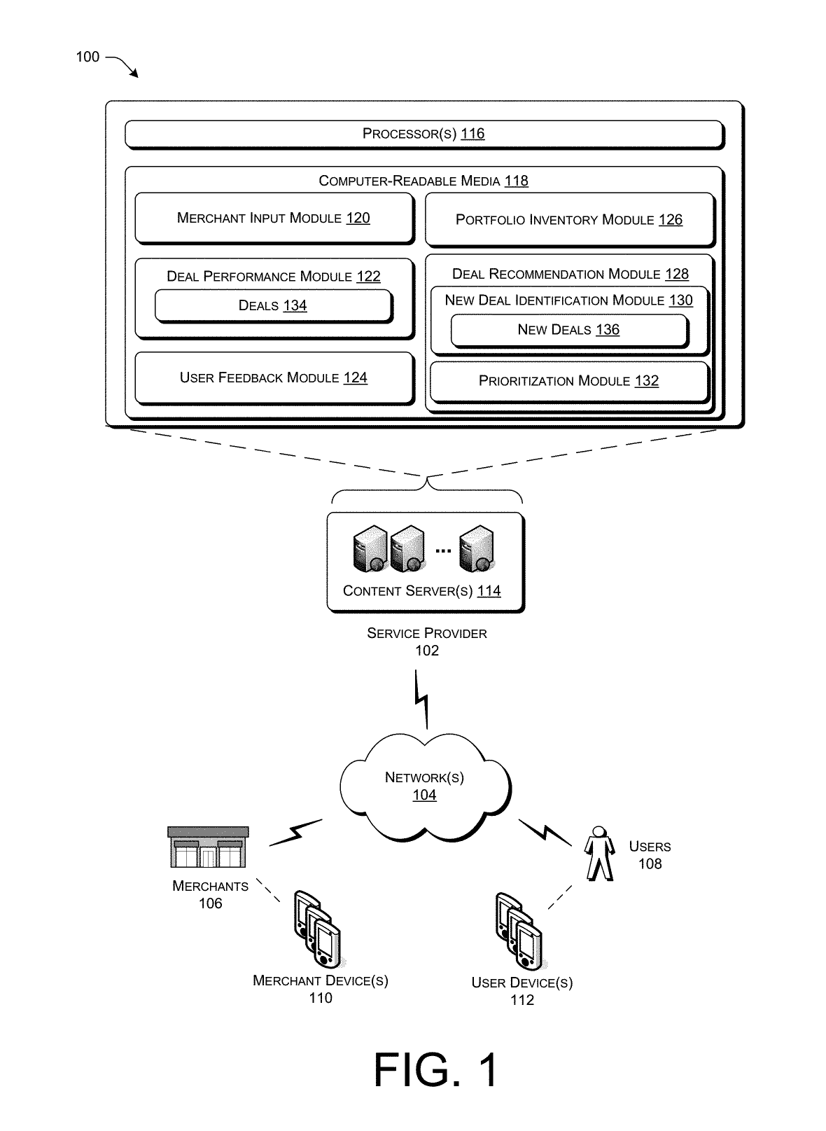

FIG. 1 illustrates an example system 100 for recommending deals provided by a service provider on behalf of merchants based on triggering events. More particularly, the system 100 may include a service provider 102, one or more network(s) 104, one or more merchants 106, one or more users 108, one or more merchant devices 110 associated with the one or more merchants 106, and one or more user devices 112 associated with the one or more users 108.

As shown, the service provider 102 may include one or more content server(s) 114, which may include one or more processor(s) 116 and computer-readable media 118. The computer-readable media 118 may include a merchant input module 120, a deal performance module 122, a user feedback module 124, a portfolio inventory module 126, and a deal recommendation module 128. As shown, the deal performance module 122 may be associated with one or more deals 134. Additionally, as shown, the deal recommendation module 128 may include a new deal identification module 130 and a prioritization module 132. The new deal identification module 130 may be associated with one or more new deals 136.

In various embodiments, the service provider 102 may provide new deals 136 to consumers (e.g., users 108) on behalf of the merchants 106 and/or deal providers. The service provider 102 described herein may offer new deals 136 that promote or feature merchants 106 and/or merchant items. The service provider 102 may recommend new deals 136 to customers (e.g., users 108) based on a variety of factors. For example, the service provider 102 may observe user 108 information and actions associated with a retail purchase account associated with a user 108 (e.g., purchases, sales, items on a saved-items list (i.e., a wish-list), browsing history, search history, recommendations, personal demographic information, location proximity, calendar information, etc.) when recommending a new deal 136 to the customer (e.g., user 108). In another example, the service provider 102 may access and observe user 108 information and actions associated with third party sources and systems (e.g., social networks, professional networks, partner webstore purchases, etc.) when recommending a new deal 136 to a user 108. Therefore, the service provider 102 may prioritize new deals 136 based on the user 108 information and actions described above such that more relevant new deals 136 are provided to a user 108 before less relevant new deals 136. The new deals 136 may share the same characteristics as previously acquired deals 134 (i.e., a new deal 136 could be identical to a previously acquired deal 134, a new deal 136 could be a new release similar to a previously acquired deal 134, etc.), or a new deal 136 may have entirely different characteristics from previously acquired deals 134.

The service provider 102 may optimize recommending new deals 136 by recommending the new deals 136 to users 108 based on triggering events. In some embodiments, the triggering events may be associated with user 108 interaction with previously acquired deals 134. For example, triggering events may include redeeming a previously acquired deal 134, requesting a refund of a previously acquired deal 134, or allowing a previously acquired deal 134 to expire. In various embodiments, the service provider 102 may identify the triggering events based on various types of data, such as a performance of the deals 134, user feedback, a user's 108 portfolio of previously acquired deals 134, and so on. In other embodiments, the triggering events may be unrelated to users' 108 interaction with previously acquired deals 134. For example, events associated with a merchant 106 may result in a triggering event. In some circumstances, a merchant 106 may go out of business or may change locations. In other circumstances, a merchant 106 may close temporarily (e.g., for remodel, vacation, etc.) or may temporarily suspend services (e.g., due to reduction of staff). Furthermore, a merchant 106 may run out of inventory or may experience a reduction in inventory. Additional examples of triggering events that may result from circumstances outside of a user's 108 control include changes in merchant 106 or service provider 102 ownership, changes in a relationship between a merchant 106 and service provider 102, changes in a quality of goods or services provided by a merchant, changes in user reviews and/or ratings of a merchant 106, etc.

In some embodiments, the network(s) 104 may be any type of network known in the art, such as the Internet. Moreover, the service provider 102, the merchants 106, and/or the users 108 may communicatively couple to the network(s) 104 in any manner, such as by a wired or wireless connection. The network(s) 104 may facilitate communication between the content server(s) 114, merchant devices 110 associated with the merchants 106, and/or the user devices 112 associated with the users 108.

In various embodiments, the one or more merchants 106 may be any individual or entity that is a source or a distributor of items (e.g., products, services, etc.) and/or deals 134 that may be acquired by the users 108. For example, the merchants 106 may include entities that provide products or services to consumers, which may be offered or promoted directly by the merchants 106 or by the service provider 102 or a deal provider on behalf of the merchants 106. The merchants 106 may also offer those items and/or deals 134 via a physical location (e.g., a brick-and-mortar store) or a merchant-branded merchant site (e.g., website). The merchants 106 may provide items or deals 134 to the users 108 with the assistance of one or more merchant devices 110, which may include any type of device. Moreover, the merchants 106 may interact with the service provider 102 via a site (i.e., a website), a self-service merchant portal, a self-service interface, or in any other manner.

In some embodiments, the users 108 may operate corresponding user devices 112 to perform various functions associated with the user devices 112, which may include one or more processor(s), computer-readable media, and a display. Furthermore, the users 108 may utilize the user devices 112 to receive new deals 136 provided by the service provider 102, possibly on behalf of the merchants 106 or a deal provider, access or interact with those new deals 136, and possibly acquire the new deals 136. The new deals 136 may be provided to the user 108 in any manner, such as via a site (e.g., a website), an e-mail message, an application associated with a user device 112, a text message, a telephone call, a social network, or any other manner that may be used to communicate the new deals 136 to the users 108.

The service provider 102 may be any entity, server(s), platform, etc., that presents new deals 136 to users 108, where the service provider 102 may be the source of the new deals 136 or the service provider 102 may present the new deals 136 on behalf of the merchants 106 or a deal provider. Moreover, and as shown, the service provider 102 may include one or more content server(s) 114, which may include one or more processors 116 and computer-readable media 118. The content server(s) 114 may also include additional components not listed above that may perform any function associated with the content server(s) 114. In various embodiments, each of the content server(s) 114 may be any type of server, such as a network-accessible server.

In various embodiments, the processor(s) 116 may execute one or more modules and/or processes to cause the content server(s) 114 to perform a variety of functions, as set forth above and explained in further detail in the following disclosure. In some embodiments, the processor(s) 116 may include a central processing unit (CPU), a graphics processing unit (GPU), both CPU and GPU, or other processing units or components known in the art. Additionally, each of the processor(s) 116 may possess its own local memory, which also may store program modules, program data, and/or one or more operating systems.

In at least one configuration, the computer-readable media 118 of the content server(s) 114 may include any components that may be used to facilitate interaction between the service provider 102, the merchants 106 and/or the users 108. For example, the computer-readable media 118 may include the merchant input module 120, the deal performance module 122, the user feedback module 124, the portfolio inventory module 126, and the deal recommendation module 128. The deal recommendation module 128 may include the new deal identification module 130 and the prioritization module 132. Depending on the exact configuration and type of the content server(s) 114, the computer-readable media 118 may also include volatile memory (such as RAM), non-volatile memory (such as ROM, flash memory, miniature hard drive, memory card, or the like), or some combination thereof.

For the purposes of this discussion, the service provider 102 may offer new deals 136 on behalf of itself, the merchants 106, and/or a deal sourcer (e.g., a deal providers). In various embodiments, a deal sourcer may include any entity that aggregates deals 134 from any number of merchants 106 and provides those deals 134 to an entity, such as the service provider 102, which may then identify and offer relevant new deals 136 to consumers. Furthermore, the deals 134 may represent some form of value to be applied when items are acquired by individuals in association with the deals 134, such as a discount, a coupon, a credit, a rebate, and the like. The deals 134 may also represent an offer and/or promotion to acquire one or more items associated with the deals 134 or may represent one or more advertisements associated with the deals 134. The deals 134 may also be offered at any price point, including being offered at no cost, such as the users 108 being offered a deal 134 that includes an item at no additional cost to the user 108. The items offered in association with the deals 134 may include tangible items, intangible items, products, goods, services, a bundle of items, digital goods, digital services, events, and the like.

The items provided by the merchants 106, a deal provider, or the service provider 102, and then offered by the service provider 102 may be acquired by the users 108 via one or more physical locations, via one or more sites (e.g., a site of the merchant 106, a deal provider, an online retailer site, websites, etc.), via any type of user device 112, at the point of a transaction or interaction with a merchant 106, or combinations thereof. A deal provider, the merchants 106, and/or the service provider 102 may also provide items acquired by individuals to locations specified by the individuals, such as via mobile services, delivery, etc. In addition, the acquisition of items from merchants 106 or a deal provider by users 108 via the service provider 102 may be achieved through various means of providing value for the items, such as purchasing items, renting items, leasing items, borrowing items, trading items, bartering items, etc. Moreover, the deals 134 may be available to users 108 for a limited period of time and, once acquired, the deals 134 may or may not have to be redeemed within a predetermined amount of time. Users 108 may maintain or store previously acquired deals 134 in a portfolio that is associated with the user 108. For the purposes of this discussion, a user's 108 deal portfolio may include deals 134 that have been acquired, are eligible to be redeemed, and have yet to be redeemed. The user's 108 deal portfolio may exclude previously acquired deals 134 that have been redeemed, have expired, have been refunded, or are otherwise not eligible to be redeemed.

In various embodiments, the merchant input module 120 may enable the merchants 106 to provide information and/or data to the service provider 102. More particularly, the merchant input module 120 may allow the merchants 106 to provide deals 134, or merchant inputs (i.e., deal parameters) associated with a deal 134, to the service provider 102. For example, merchants 106 may provide deal parameters that include, but are not limited to, the items included in the deal 134, the price, the discount being applied, redemption locations, a redemption period (i.e., a period of time in which a user 108 may redeem the deal 134), a structure of the deal 134, a format of the deal 134 (e.g., text versus graphics/symbols), a visual appearance of the deal 134, (e.g., text, symbols, colors, images, etc., to be displayed with the deal 134), users 108 or groups of users 108 that are to receive the deal 134, and any other terms or conditions associated with the deal 134.

In various embodiments, the merchant 106 may provide the merchant inputs to the service provider 102 in a self-service manner, such as via a site (i.e., a website, a merchant portal, an interface, etc.) that is associated with the service provider 102 and that is accessible by the merchants 106. In various embodiments, the merchants 106 may provide such information via a site (i.e., a website) and/or a merchant portal that is associated with the service provider 102 and that is accessible by the merchants 106. The merchant portal may refer to a self-service interface that enables the service provider 102 and the merchants 106 to communicate with one another and/or to provide data (i.e., merchant inputs, deals 134, etc.) to one another.

In response to providing deals 134 to users 108 on behalf of the merchants 106, the deal performance module 122 may determine a past or current performance of the deals 134. In some embodiments, performance may refer to whether a deal 134 is redeemed by a user 108, whether a user 108 requests a refund for a previously acquired deal 134, or whether a previously acquired deal 134 expires before the deal 134 is redeemed. For example, in various embodiments, previously acquired deals 134 may be redeemed when the deals 134 are acquired or at a later time. Provided that a particular deal 134 is redeemed at a later time, the user 108 that acquired the deal 134 may provide a code to redeem the deal 134, where the code may have been provided to the user 108 when the deal 134 was acquired. The code may take any form (e.g., numbers, letters, symbols, combinations thereof, etc.) and may be provided to the merchant 106, a deal provider, or may be used to redeem the deal 134 in any manner. For example, a particular user 108 may redeem the deal 134 by physically providing the code to a merchant 106 or a deal provider (e.g., via a physical medium), by presenting the code via a user device 112, by swiping a card (e.g., a credit card, a card associated with a merchant 106, etc.), etc. In addition, the deals 134 may be paid for when they are acquired or at a subsequent time, such as, for example, when the user 108 redeems the deal 134 at the merchant 106.

Alternatively, a user 108 may request a refund for a previously acquired deal 134 for a variety of reasons. For instance, the user 108 may determine that they will no longer use/need the deal 134, the user 108 may identify an additional deal 134 that is of greater interest, or the user 108 may determine that they have a duplicate deal 134 in their deal portfolio. In various embodiments, a user 108 may request a refund for a previously acquired deal 134 when the deal 134 is acquired or at a later time. The user 108 that acquired the deal 134 may request a refund at a self-service website, an application on a user device 112, or via customer service associated with the service provider 102 and/or the merchant 106 associated with the deal 134. Upon completing the refund request, the user 108 may receive a refund at the time the refund request is completed (e.g., an immediate deposit into a user's 108 electronic wallet or a refund directly back to a card used to acquire the deal 134). Alternatively, the user 108 may receive a refund at a subsequent time, such as, for example, when the service provider 102 mails a check or a card (e.g., a card associated with a merchant 106, a card associated with the service provider, etc.). In at least some embodiments, a user 108 may be prompted to provide user feedback at the time of the refund request articulating reasons for requesting the refund and/or whether the user 108 wishes to receive subsequent offers for deals 134 having similar characteristics. A user may provide user feedback via a self-service website, an application or browser on a user device 112, customer service, etc.

Additionally, a deal 134 previously acquired by the user 108 may expire if the user 108 fails to redeem the deal 134 prior to a date provided by merchant parameters. In at least some embodiments, upon expiration of a previously acquired deal 134, a user 108 may receive a credit in the amount of a cost of the previously acquired deal 134, which may be redeemed to the merchant 106 at a subsequent time.

In other embodiments, the deal performance module 122 may identify characteristics relevant to a particular deal 134 (e.g., merchant, category, subcategory, price, geographic location, etc.). The deal performance module 122 may provide data to the portfolio inventory module 126 regarding performance of the deals 134 and relevant characteristics associated with the deals 134. Additionally, the performance of the deals 134, the relevant characteristics, and/or the merchant inputs associated with those deals 134 may be utilized by the deal recommendation module 128 to recommend new deals 136 to the users 108.

The user feedback module 124 may utilize user feedback associated with users 108 to determine characteristics relevant to the users 108. Users 108 may provide feedback relevant to previously acquired deals 134, describing preferences, interests, likes/dislikes, complaints, etc. For instance, the user feedback data 212 may include a type of user feedback (e.g., positive, neutral, negative, and/or blacklist user feedback) and may include feedback provided directly from consumers, user ratings relating to items and/or merchants 106, user reviews of items and/or merchants 106, user responses to surveys and/or questionnaires, customer service feedback, information from sites (i.e., websites), and so on. In some embodiments, user feedback determined to be blacklist feedback may indicate that the user 108 does not desire to receive recommendations for new deals 136 having characteristics similar to those identified in the blacklist feedback. As a result of receiving user feedback, the user feedback module 124 may determine trends regarding what users 108 prefer or like and what users 108 complain about or dislike. Users 108 may provide feedback via a self-service website, application or browser on a user device 112, customer service, etc. In some embodiments, the user feedback module 124 may leverage user-provided feedback, user reviews, user ratings, user responses to surveys/questionnaires, etc., to determine preferences, interests, likes/dislikes, complaints, etc., of users 108. The deal recommendation module 128 may utilize the type of feedback to customize recommendations of new deals 136 to users 108.

The portfolio inventory module 126 may track and record the deals 134 that a particular user 108 acquires, redeems, and loses (e.g., expired or refunded deals 134) over time. In some embodiments, the portfolio inventory module 126 determines trends, preferences, or characteristics relevant to users 108 based on the tracking and recording. For example, the portfolio inventory module 126 may leverage whether a user redeemed a previously acquired deal 134, whether a user requested a refund, or whether a user allowed a previously acquired deal 134 to expire, to determine preferences, interests, likes/dislikes, rates of redemption, refund requests, or expiration (e.g., the number of times a user 108 redeems, requests a refund, or permits a deal 134 to expire in a predetermined amount of time), etc., associated with users 108. The portfolio inventory module 126 may determine when a user's 108 portfolio experiences a change in a number or type of previously acquired deals 134 that were previously stored in the portfolio. Additionally, the portfolio inventory module 126 may compare known user 108 preferences with a current inventory of deals 134 stored in the user's 108 portfolio and may determine that a user's 108 portfolio has a gap such that the user's 108 current deals 134 are not fully representative of the user's 108 preferences. The portfolio inventory module 126 may communicate the information described above as to the deal recommendation module 128.

Moreover, the deal recommendation module 128 may recommend new deals 136 to the users 108. In at least one embodiment, the deal recommendation module 128 communicates with the new deal identification module 130 and the prioritization module 132. The new deal identification module 130 may use data from the merchant input module 120, the deal performance module 122, the user feedback module 124, and/or the portfolio inventory module 126 to identify new deals 136 based at least in part on relevant user characteristics, trends, preferences, merchant inputs, and/or relevant characteristics of previously acquired deals 134. The new deal identification module 130 may identify new deals 136 from an inventory of deals 134 at the time a triggering event occurs. Alternatively, the new deal identification module 130 may identify new deals 136 at some time subsequent to the triggering event from an inventory of deals 134.

The prioritization module 132 prioritizes new deals 136 to be recommended to a user 108 based at least in part on the information received from the merchant input module 120, the deal performance module 122, the user feedback module 124, and/or the portfolio inventory module 126. In certain embodiments, the prioritization module 132 may determine and/or maintain one or more rules that dictate which new deals 136 are to be provided to the user 108. For instance, the prioritization module 132 may prioritize the new deals 136, such that higher prioritized new deals 136 may be displayed more prominently and/or emphasized more than lower prioritized new deals 136. In addition, the prioritization module 132 may prioritize new deals 136, such that higher prioritized new deals 136 may be recommended at a rate higher than lower prioritized new deals 136. In additional embodiments, the prioritization module 132 may de-prioritize the new deals 136, such that de-prioritized new deals 136 may be displayed less prominently and/or de-emphasized. In addition, the prioritization module 132 may de-prioritize new deals 136, such that de-prioritized new deals 136 may be recommended at a rate lower than higher prioritized new deals 136. Then, if the service provider 102 is able recommend multiple different new deals 136 to a particular user 108, the prioritization module 132 may determine which of the new deals 136 should initially be provided to a user 108.

The system 100 for recommending new deals 136 based on triggering events associated with previously acquired deals 134 may also be extensible to new triggering events and/or new consequences over time.

### Deal Recommendations

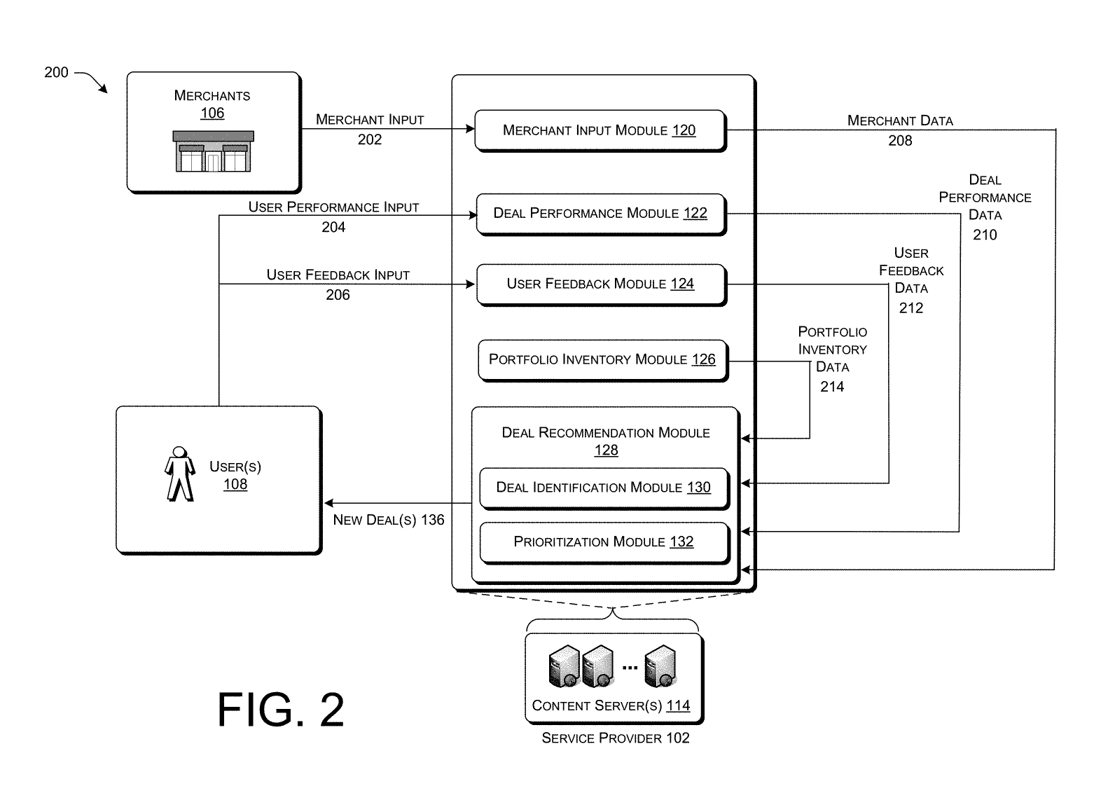

FIG. 2 is a diagram showing an example system for utilizing one or more types of data to generate recommendations for new deals 136 based at least in part on triggering events. As shown in FIG. 2, the system 200 may include one or more merchants 106, one or more users 108, and the service provider 102, which may include the one or more content server(s) 114. The content server(s) 114 may also include at least some of the various modules discussed above with respect to FIG. 1. The one or more merchants 106 may provide merchant input 202 to the content server(s) 114. Furthermore, the one or more users 108 may provide user performance input 204 and/or user feedback input 206 to the content server(s) 114.

In various embodiments, assuming that a merchant 106 is providing a deal 134 to the service provider 102 (the service provider 102 may also provide deals 134 directly to the users 108), the merchant 106 may identify or select one or more merchant inputs 202 that relate to the deal 134. For example, merchants 106 may provide deal parameters including, but not limited to, parameters limiting the number of deals 134 a particular user 108 may acquire or parameters establishing the amount of time a user 108 has to redeem the previously acquired deals 134. In various embodiments, the merchant 106 may provide the merchant inputs 202 to the service provider 102 in a self-service manner, such as via a site (i.e., a website, a merchant portal, an interface, etc.) that is associated with the service provider 102 and that is accessible by the merchants 106. The merchant input module 120 may provide the merchant deal parameters as merchant data 208 to the deal recommendation module 128.

As discussed above with respect to FIG. 1, the service provider 102 may present deals 134 to users 108 on behalf of the merchants 106, who may be offering items (e.g., products, services, etc.) that are featured or promoted in the deals 134. Users 108 may interact with the deals 134 in various ways. For example, users 108 may view, click through, access, acquire (e.g., buy), etc., the deals 134. Once users 108 acquire one or more deals 134, the one or more deals 134 may be stored in the user's 108 portfolio. A user 108 may interact with a previously acquired deal 134 such to cause the previously acquired deal 134 to be removed from the user's 108 portfolio. For example, a user 108 may redeem a deal 134, request a refund for a deal 134, or allow a deal 134 to expire. Such interactions by a user 108 may be determined to be user performance input 204. Furthermore, the service provider 102 may consider one or more of the user performance inputs 204 to be a triggering event leveraged by the service provider 102 to recommend new deals 136.

Moreover, the deal performance module 122 may determine deal performance data 210 for the deals 134 that the service provider 102 presented directly to users 108 and/or deals 134 that the service provider 102 provided to users 108 on behalf of the merchant 106 and/or other merchants 106. Examples of deal performance data 210 may correspond to the actual performance of deals 134, which may include an extent to which the deals 134, or the items associated with the deals 134, were viewed, clicked through, accessed, acquired (e.g., sold), redeemed, fulfilled, added to a saved-items list (e.g., a wish list), etc., and/or the revenue or profits resulting from the acquisition of the deals 134. Additionally, deal performance data 210 may correspond to the extent to which users 108 request refunds for previously acquired deals 134 or permit deals 134 to expire.

In addition to tracking the performance of the deals 134, the deal performance module 122 may identify characteristics of particular deals 134 (e.g., merchant(s) associated with products or services featured in the deals 134, a category of products and/or services associated with the deals 134, a subcategory of the products and/or services associated with the deals 134, a price paid to acquire the deal 134, a geographic location associated with the deals 134 and/or the merchant 106, etc.). The deal performance module 122 may identify characteristics and performance of a particular deal 134 with respect to characteristics and performance of other deals 134, where the other deals 134 may be deals 134 in the same category as the deal 134, deals 134 that feature the same, or similar, items, deals 134 that were provided to users 108 in the same geographic area, deals 134 that were provided to similarly situated users 108 (e.g., users 108 in the same demographic groups, users 108 having similar preferences, likes/dislikes, etc.), and so on. Therefore, the deal performance module 122 may determine trends or implicit preferences of a user 108 based on the deal performance data 210. The deal performance module 122 may provide the deal performance data 210 to the deal recommendation module 128 for recommending new deals 136.

The user feedback module 124 may collect, receive, obtain and/or determine user feedback input 206 from users 108. More particularly, the user feedback module 124 may leverage user feedback input 206 (e.g., user-provided feedback, user reviews, user ratings, user responses to surveys/questionnaires, etc.), to determine preferences, interests, likes/dislikes, complaints, etc., of users 108. From the user feedback data 212, the user feedback module 124 may determine the preferences, interest, likes/dislikes, complaints, etc., for users 108 in different geographic areas and/or similarly situated users 108, such as users 108 in the same group, users 108 having similar demographics, users 108 that have expressed an interest in the same/similar items or merchants 106, and so on. As a result, the user feedback module 124 may determine trends regarding what users 108 prefer or like and what users 108 dislike or complain about. The user feedback module 124 may provide the user feedback data 212 to the deal recommendation module 128 for recommending new deals 136.

The portfolio inventory module 126 may collect, receive, obtain, and/or determine portfolio inventory data 214 relating to an inventory of deals 134 included in a users' 108 deal portfolio. For example, the portfolio inventory module 126 may track and record deals 134 that a particular user 108 acquires and loses (e.g., via redemption, expiration, refund request, etc.) over time. In some embodiments, the portfolio inventory module 126 may collect, receive, obtain, and/or determine portfolio inventory data 214 relating to trends and/or preferences relevant to users 108 and/or characteristics relevant to previously acquired deals 134 (e.g., merchant, category, subcategory, price, geographic location, etc.). For example, the portfolio inventory module 126 may leverage whether a user 108 redeemed a previously acquired deal 134, whether a user 108 requested a refund of a previously acquired deal 134, or whether a user 108 allowed a previously acquired deal 134 to expire, to determine preferences, interests, likes/dislikes, rates of redemption, refund request, or expiration of deals 134, etc., associated with users 108. The portfolio inventory module 126 may collect, receive, obtain, and/or determine portfolio inventory data 214 relating to whether a user's 108 portfolio experiences a change in a number or type of previously acquired deals 134 previously stored in the portfolio.

Additionally, the portfolio inventory module 126 may compare relevant user 108 preferences to a current inventory of deals 134 in the user's 108 portfolio and may determine that a user's 108 portfolio has a gap such that the user's 108 previously acquired deals 134 that have not expired or been redeemed, are not fully representative of the user's 108 preferences. For example, if the portfolio inventory module 126 determines that a user 108 regularly acquires deals 134 for wine tastings, pedicures, and yoga classes, the portfolio inventory module 126 will determine that the user 108 prefers deals 134 in such categories. When the portfolio inventory module 126 observes that a user's 108 portfolio is lacking deals 134 for pedicures, for instance, the portfolio inventory module 126 may identify a gap in the user's 108 portfolio with respect to deals featuring pedicures. The portfolio inventory module 126 may provide the portfolio inventory data 214 to the deal recommendation module 128 for recommending new deals 136, such as new deals 136 featuring a pedicure.

In various embodiments, the deal recommendation module 128 may recommend new deals 136 to the users 108. More particularly, the deal recommendation module 128 may utilize the deal identification module 130 and the prioritization module 132 to identify and prioritize new deals 136 based at least in part on the merchant data 208, deal performance data 210, the user feedback data 212, and/or the portfolio inventory data 214 to identify new deals 136 in an inventory of deals 134 based at least in part on the new deals 136 having at least some relevant characteristics similar to those determined for previously acquired deals 134. Over time, the deal performance module 122, user feedback module 124, and portfolio inventory module 126 may imply user 108 preferences based at least in part on characteristics of previously acquired deals 134, repeat acquisitions of deals 134 sharing at least some characteristics, rates of redemption, expiration, and/or refund requests for deals 134 sharing at least some characteristics, etc. The deal identification module 130 may identify new deals 136 based at least in part on the implied user 108 preferences.

In some embodiments, the deal identification module 130 may identify new deals 136 sharing at least some characteristics (e.g., the same merchant, category, subcategory, price, and/or geographic location) as the previously acquired deal 134 associated with the triggering event. For example, if a user 108 acquires a deal for lunch at a Mexican restaurant, upon redemption of the Mexican lunch deal, the deal identification module 130 may identify a new deal 136 that shares at least some of the characteristics associated with the Mexican lunch deal, such as a new deal 136 offered by the same merchant 106, a new lunch deal 216, or a new deal 136 for food from a Mexican restaurant. In some embodiments, the deal identification module 130 may identify new deals 136 that may be redeemed in geographical locations similar to previously acquired deals 134. For example, if a user 108 regularly acquires deals 134 in the South Lake Union neighborhood of Seattle, Washington, the deal identification module 130 may identify new deals 136 that may be redeemed from merchants 106 in the South Lake Union neighborhood.

The deal identification module 130 may also identify new deals 136 based at least in part on a location triggering event (e.g., location of redemption, check-in, geo-tag, etc.). For example, if a user 108 redeems a deal at Recreational Equipment, Inc.® (REI®) in South Lake Union, the deal identification module 130 may identify new deals 136 in the South Lake Union area. Additionally, if a user 108 checks-in at a Starbucks® in South Lake Union, the deal identification module 130 may identify new deals 136 in the South Lake Union area. In other embodiments, a user could take a photo or relay other information that comprises a geo-tag identifying the user's 108 location, and the deal identification module 130 may identify new deals 136 that may be redeemed in or near the area identified by the geo-tag.

Moreover, the deal identification module 130 may identify new deals 136 based at least in part on temporal or calendar information (e.g., time of day, a day of the week, a season, etc.). In at least some embodiments, the deal identification module 130 may identify a new deal 136 based in part on a time of day a triggering event occurred. For example, if a user 108 redeems a deal 134 in the morning (e.g., a breakfast deal) the deal identification module 130 may identify new deals 136 that also may be redeemed in the morning (e.g., coffee, morning yoga, fitness boot camp, etc.). The deal identification module 130 may identify new deals 136 based at least in part on a day of the week or time of year. For example, if a user 108 redeems a lunch deal 134 on a weekday in downtown Seattle, the deal identification module 130 may determine that the deal 134 was redeemed on a weekday (as opposed to a weekend) and in the geographic area of downtown Seattle. The deal identification module 130 may identify a new deal 136 that may be offered on a weekday in downtown Seattle. For instance, the deal identification module 130 may identify a new deal 136 for a parking discount in downtown Seattle that may only be redeemed by a user 108 on weekdays. Alternatively, if a user 108 redeems a deal 134 during a winter month at the Steven's Pass Ski Resort in Washington State, the deal identification module 130 may identify new deals 136 that may be redeemed during the winter (e.g., skiing, snowboarding, accommodations, vacations, etc.) and/or new deals 136 associated with merchants 106 that are located in the same geographic area.

Additionally, the deal identification module 130 may identify new deals 136 based at least in part on a user's 108 friends' portfolios of previously acquired deals 134. For example, if a user 108 and one of the user's 108 friends regularly acquire deals 134 having at least some of the same characteristics, the deal identification module 130 may identify new deals 136 having characteristics similar to those of a deal 134 recently acquired by the user's friend.

In at least some embodiments, the deal identification module 130 may identify new deals 136 based at least in part on a combination of the factors described above and/or on other factors (e.g., demographics, click and/or purchase history, etc.).

The prioritization module 132 may prioritize new deals 136 that are identified by the deal identification module 130 and that are to be provided to users 108. That is, the prioritization module 132 may prioritize the new deals 136 that are likely to be most relevant, and of particular interest to, the users 108. In various embodiments, when the deal identification module 130 identifies more than one new deal 136, the prioritization module 132 may prioritize the new deals 136 based at least in part on the merchant data 208, deal performance data 210, user feedback data 212, and/or portfolio inventory data 214. The particular prioritizing of the new deals 136 may influence which new deals 136 are presented to users 108, the order in which the new deals 136 are to be presented, and/or the amount of emphasis on those new deals 136 when the new deals 136 are provided to consumers. For instance, higher prioritized new deals 136 may be placed in a higher and more visible/desirable deal slot, may be emphasized in some manner (e.g., larger, brighter/bolder colors, larger font, symbols, images, etc., higher quality images, placed in a high traffic area, and so on), may be provided to users 108 in a single communication, may be recommended more frequently, etc. Therefore, higher prioritized new deals 136 are more likely to be viewed, clicked on, etc., since they are more visible to consumers. In alternative embodiments, de-prioritized new deals 136 may be placed in a lower and less visible/desirable deal slot, may be de-emphasized in some manner, may be recommended less frequently, may not be provided to users 108, etc. Therefore, de-prioritized new deals 136 are less likely to be viewed, clicked on, etc., since they are less visible to consumers or not provided to consumers altogether.

The prioritization module 132 may prioritize new deals 136 based at least in part on a rate a user 108 interacts (e.g., redeems, requests a refund, allows expiration, etc.) with deals 134 having similar characteristics. In some embodiments, if a user 108 redeems a deal 134 from a particular subcategory (e.g., Thai food) once per week and redeems deals 134 from other subcategories (e.g., Mexican food, etc.) once per month, the prioritization module 132 may prioritize new deals 136 having at least some similar characteristics as deals 134 having higher redemption rates (e.g., deals for Thai food) ahead of other new deals 136 in the same category (e.g., deals for food) or different subcategories (e.g., deals for Mexican food, etc.). Alternatively, if a user 108 allows deals 134 having certain characteristics to expire more frequently than deals 134 having different characteristics, the prioritization module 132 may de-prioritize new deals 136 having at least some characteristics similar to the certain characteristics of the deals 134 that the user 108 allows to expire more frequently.

As described above, merchants 108 may provide merchant inputs 202 (i.e., deal parameters) associated with deals 134 to the service provider 102. The prioritization module 132 may prioritize new deals 136 based at least in part on the merchant inputs 202. For example, a deal parameter may limit the number of deals 134 a user 108 may acquire. The prioritization module 132 may consider the deal parameter in prioritizing a deal 134 for recommendation to a user 108 and may prioritize new deals 136 whereby the user 108 has not reached the limit, or may de-prioritize new deals 136 whereby the user 108 has reached the limit. Other merchant inputs 202 may be used as well.

Furthermore, the prioritization module 132 may prioritize new deals 136 based at least in part on gaps identified in a user's 108 portfolio. As described above, the deal performance data 210 and the portfolio inventory data 214 may identify user 108 preferences based at least in part on the characteristics of previously acquired deals 134. The portfolio inventory module 126 may identify a gap in a user's 108 profile when the user's 108 portfolio lacks one or more deals 134 relevant to or corresponding with all of a user's 108 preferences. In some embodiments, when a gap is identified, the prioritization module 132 may prioritize a new deal 136 having characteristics sufficient to fill the gap. For example, if the deal performance data 210 and the portfolio inventory data 214 indicate that a user 108 prefers deals 134 for coffee, deals 134 for massages, and deals 134 that may be redeemed in the South Lake Union neighborhood, but the user's 108 portfolio does not include any deals 134 for coffee, the prioritization module 132 may prioritize new deals 136 for coffee before new deals 136 for massages. Furthermore, the prioritization module 132 may prioritize new deals 136 for coffee in South Lake Union over new deals 136 in other areas in Seattle.

The deal recommendation module 128 may recommend new deals 136 to the users 108 via the deal identification module 130 and the prioritization module 132 based at least in part on the merchant data 208, deal performance data 210, user feedback data 212, and/or portfolio inventory data 214. In at least some embodiments, the deal recommendation module 128 may recommend a new deal 136 to a user 108 via email messages, SMS messages, or an application or browser associated with a user device 112. In other embodiments, new deals 136 may be recommended to users 108 via an interface of a self-service provider. The deal recommendation module 128 may recommend new deals 136 instantaneous with, close in time after, or several days or more following a triggering event. For example, if a user 108 redeems a previously acquired deal 134 using the application or browser associated with his or her user device 112, the deal recommendation module 128 may present a new deal 136 to the user 108 via the application or browser of his or her user device 112 at the same time the previously acquired deal 134 is redeemed. Alternatively, the deal recommendation module 128 may recommend a new deal 136 and an indication from a user 108 may add the new deal 136 to a saved-items list (i.e., a wish-list) or similar queue. If the new deal 136 is added to a saved-items list or similar queue, the new deal 136 may be presented to the user 108 upon a subsequent interaction with the service provider 102.

### Example Processes

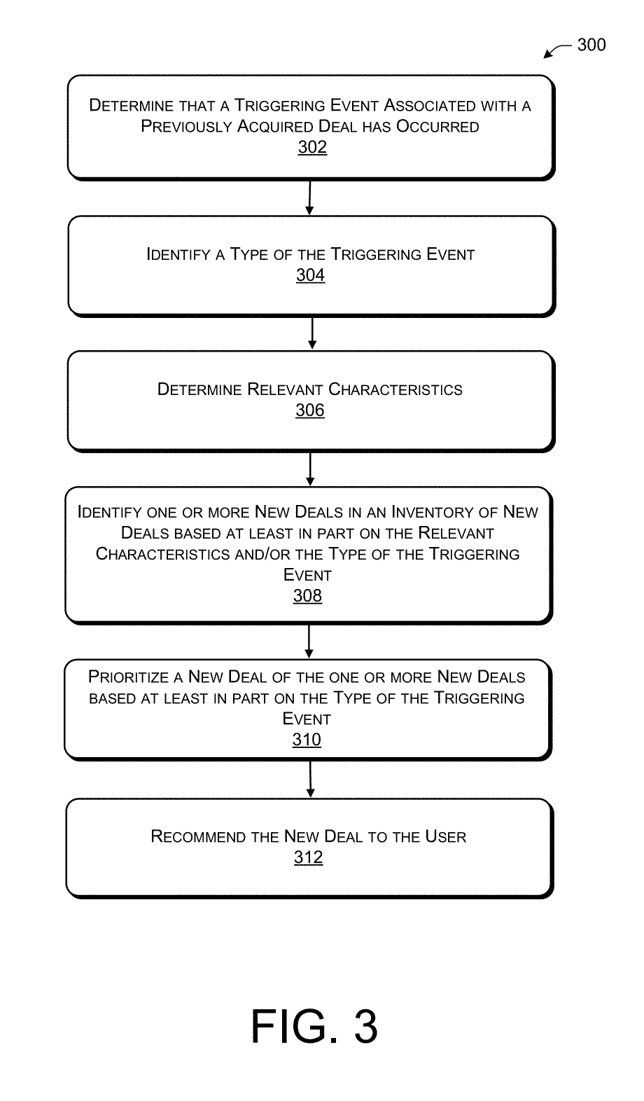

FIGS. 3-9 describe example processes for recommending new deals 136 to users 108 based on triggering events. The example processes are described in the context of the environment of FIGS. 1 and 2 but are not limited to those environments. The processes are illustrated as logical flow graphs, each operation of which represents a sequence of operations that may be implemented in hardware, software, or a combination thereof. In the context of software, the operations represent computer-executable instructions stored on one or more computer-readable media 118 that, when executed by one or more processors 116, perform the recited operations. Generally, computer-executable instructions include routines, programs, objects, components, data structures, and the like that perform particular functions or implement particular abstract data types.

The computer-readable media 118 may include non-transitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some embodiments the computer-readable media 118 may include a transitory computer-readable signal (in compressed or uncompressed form). Examples of computer-readable signals, whether modulated using a carrier or not, include, but are not limited to, signals that a computer system hosting or running a computer program may be configured to access, including signals downloaded through the Internet or other networks. Finally, the order in which the operations are described is not intended to be construed as a limitation, and any number of the described operations may be combined in any order and/or in parallel to implement the process.

FIG. 3 is a flow diagram illustrating an example process of recommending new deals 136 to consumers (e.g., users 108) based on triggering events. Moreover, the following actions described with respect to FIG. 3 may be performed by the service provider 102 and/or the content server(s) 114.

Block 302 illustrates determining that a triggering event associated with a previously acquired deal 134 has occurred. In one or more embodiments, a triggering event may occur when a user 108 redeems, requests a refund, allows expiration, etc. of a previously acquired deal 134, as described above. In some embodiments, user feedback may be identified as a triggering event. Additionally, indications of a user's 108 geographic location (e.g., user check-in, etc.) may be identified as a triggering event. In other embodiments, identifying a gap in a user's 108 portfolio may be identified as a triggering event. As described above, trigger events may also include events associated with merchants 106 and/or service providers 102 that occur outside of a user's control and without user interaction.

Block 304 illustrates identifying a type of the triggering event. The service provider 102 may identify the triggering event based on a type of user input received (e.g., user performance input 204, user feedback input 206, etc.) and/or other indicators identified by the service provider 102 (e.g., gap in user's 108 portfolio, etc.).

Block 306 illustrates determining relevant characteristics of the previously acquired deal 134, user feedback, gap, etc. The deal performance module 122, user feedback module 124, and/or portfolio inventory module 126 may determine relevant characteristics of the previously acquired deals 134, user feedback, gap, etc. As described above, relevant characteristics include, but are not limited to, merchant(s) 106 associated with the deals 134, categories of products and/or services associated with the deals 134 (e.g., food, spa, fitness, etc.), subcategories of products and/or services associated with the deals 134 (e.g., Mexican food, Thai food, Italian food, etc.), geographical locations where the deals 134 can be redeemed or the merchant(s) 106 are located, etc.

Block 308 illustrates identifying one or more new deals 136 in an inventory of new deals 136 based at least in part on the relevant characteristics and/or the type of the triggering event. As described above, the deal identification module 130 may use the merchant data 208, deal performance data 210, user feedback data 212, and/or portfolio inventory data 214 to identify new deals 136 in an inventory of new deals 136 based at least in part the new deals 136 having at least some characteristics similar to those identified in previously acquired deals 134, user feedback, gap, etc.

Block 310 illustrates prioritizing a new deal 136 of the one or more new deals 136 based at least in part on the type of the triggering event. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214. The prioritization module 132 may also prioritize new deals 136 based at least in part on predetermined rates of redemption, expiration, and/or refund requests, and/or identifying gaps in a user's 108 portfolio. As described above, the prioritization of new deals 136 may dictate whether the new deals 136 are provided to users 108, the presentation, frequency, and/or order that the new deals 136 are provided to users 108. For instance, higher prioritized new deals 136 may be placed in a higher and more visible/desirable deal slot, may be emphasized in some manner, may be provided to users 108 in a single communication, may be recommended more frequently, etc. In alternative embodiments, de-prioritized new deals 136 may be placed in a lower and less visible/desirable deal slot, may be de-emphasized in some manner, may be recommended less frequently, etc.

Block 312 illustrates recommending the new deals 136 to the user 108. As described above, in at least some embodiments, the deal recommendation module 128 may recommend new deals 136 to a user 108 via a site associated with the service provider 102, email messages, SMS messages, an application or browser associated with a user device 112, etc. The deal recommendation module 128 may recommend new deals 136 instantaneous with, close in time after, or at a subsequent time following a triggering event. Alternatively, new deals 136 may be added to a saved-items list or similar queue upon indication from a user 108.

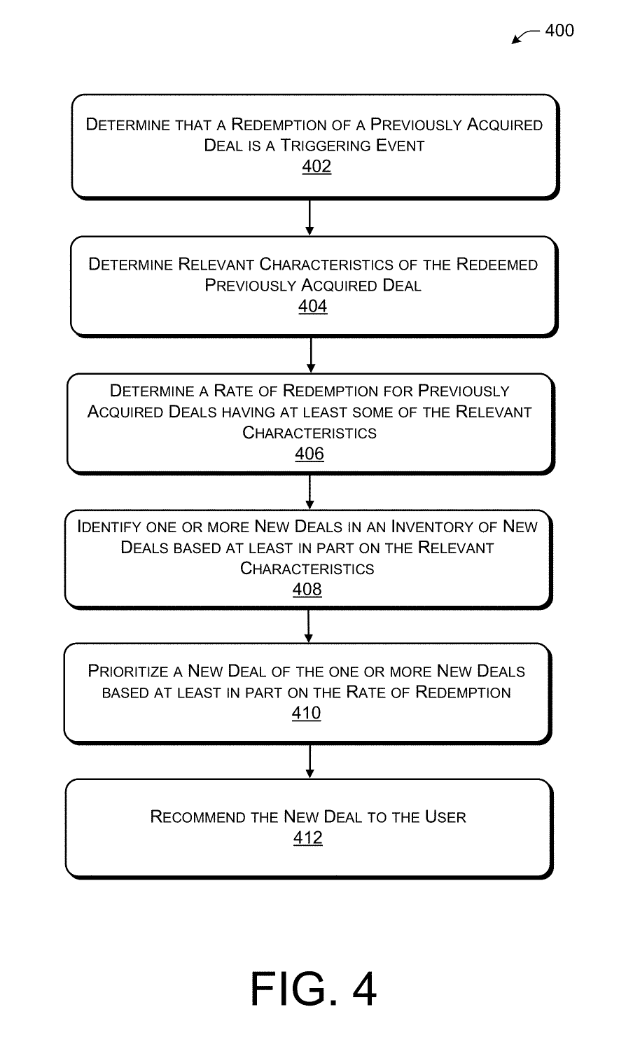

FIG. 4 is a flow diagram illustrating an example process of recommending new deals 136 to consumers (e.g., users 108) based on a redemption of a previously acquired deal 134. Moreover, the following actions described with respect to FIG. 4 may be performed by the service provider 102 and/or the content server(s) 114.

Block 402 illustrates determining a redemption of a previously acquired deal 134 to be a triggering event. As described above, a user may redeem a previously acquired deal 134 when the deal 134 is acquired or at a later time. In some embodiments, the user 108 who acquired the deal 134 may provide a code to redeem the deal 134, where the code may have been provided to the user 108 when the deal 134 was acquired. For example, a particular user 108 may redeem the deal 134 by physically providing the code to a merchant 106 or a deal provider (e.g., via a physical medium), by presenting the code via a user device 112, by swiping a card (e.g., a credit card, a card associated with a merchant 106, etc.), etc. Users 108 may redeem deals 134 in other ways as well (e.g., presenting a coupon, etc.)

Block 404 illustrates determining relevant characteristics of the redeemed previously acquired deal 134. As described above, the deal performance module 122, user feedback module 124, and/or portfolio inventory module 126 may determine relevant characteristics of the previously acquired deals 134.

Block 406 illustrates determining a rate of redemption for previously acquired deals having at least some of the relevant characteristics. In some embodiments, the portfolio inventory module 126 may determine a rate of redemption based at least in part on the frequency a user 108 redeems previously acquired deals 134 having at least some similar characteristics.

Block 408 illustrates identifying one or more new deals 136 in an inventory of new deals 136 based at least in part on the relevant characteristics. As described above, the deal identification module 130 may use the merchant data 208, deal performance data 210, user feedback data 212, and/or portfolio inventory data 214 to identify new deals 136 in an inventory of new deals 136 based at least in part on the new deals 136 having at least some characteristics similar to those identified in the redeemed previously acquired deal 134. For example, if a user 108 redeems a previously acquired deal 134 for Mexican food at Taco Cabana, the deal identification module 130 may identify new deals 136 in the service provider's 102 inventory from Taco Cabana. Alternatively or additionally, the deal identification module 130 may identify new deals 136 for Mexican food. In at least some embodiments, the deal identification module 130 may consider the geographic location where the user redeemed the previously acquired deal 134, temporal information pertinent to the redemption, and/or other characteristics as described above for identifying the one or more new deals 136.

Block 410 illustrates prioritizing a new deal 136 of the one or more new deals 136 based at least in part on the rate of redemption. As described above, in various embodiments, when the deal identification module 130 identifies more than one new deal 136 for recommendation, the prioritization module 132 may prioritize the new deals 136 based at least in part on the merchant data 208, deal performance data 210, user feedback data 212, and/or portfolio inventory data 214. The prioritization module 132 may also prioritize deals 134 based at least in part on relative rates of redemption. That is, when a user repeatedly redeems deals 134 from a particular merchant 106, category, subcategory, price, and/or geographic location, the deal performance module 122 and/or portfolio inventory module 126 may recognize such behavior as a user 108 preference and may prioritize new deals 136 from the same merchants 106, categories, subcategories, prices, and/or geographic locations.

In at least some embodiments, prioritizing new deals 136 may comprise increasing a frequency of recommendations. For example, if a user 108 redeems previously acquired deals 134 for Mexican food once per week and redeems previously acquired deals 134 for Thai food once per month, the prioritization module 132 may prioritize new deals 136 for Mexican food over new deals 136 for Thai food. Therefore, the deal recommendation module 128 may recommend new deals 136 for Mexican food prior to, and more frequently than, new deals 136 for Thai food. In an additional example, if User A redeems previously acquired deals 134 for Mexican food one time per week and User B redeems previously acquired deals for Mexican food one time per month, the prioritization module 132 may prioritize new deals 136 for Mexican food differently for User A and User B such that User A receives recommendations for new deals 136 for Mexican food more frequently than User B. In at least some embodiments, if a user 108 redeems previously acquired deals 134 at a rate above a predetermined threshold, the user 108 may become a preferred user and may receive additional benefits (e.g., highly discounted offers for deals) and/or qualify for a rewards program associated with the merchant 106, service provider, etc. For instance, a preferred user may receive special notifications when the service provider 102 offers a new deal 136 from a preferred merchant 106.

Block 412 illustrates recommending the new deal 136 to the user 108. As described above, in at least some embodiments, the deal recommendation module 128 may recommend new deals 136 to a user.

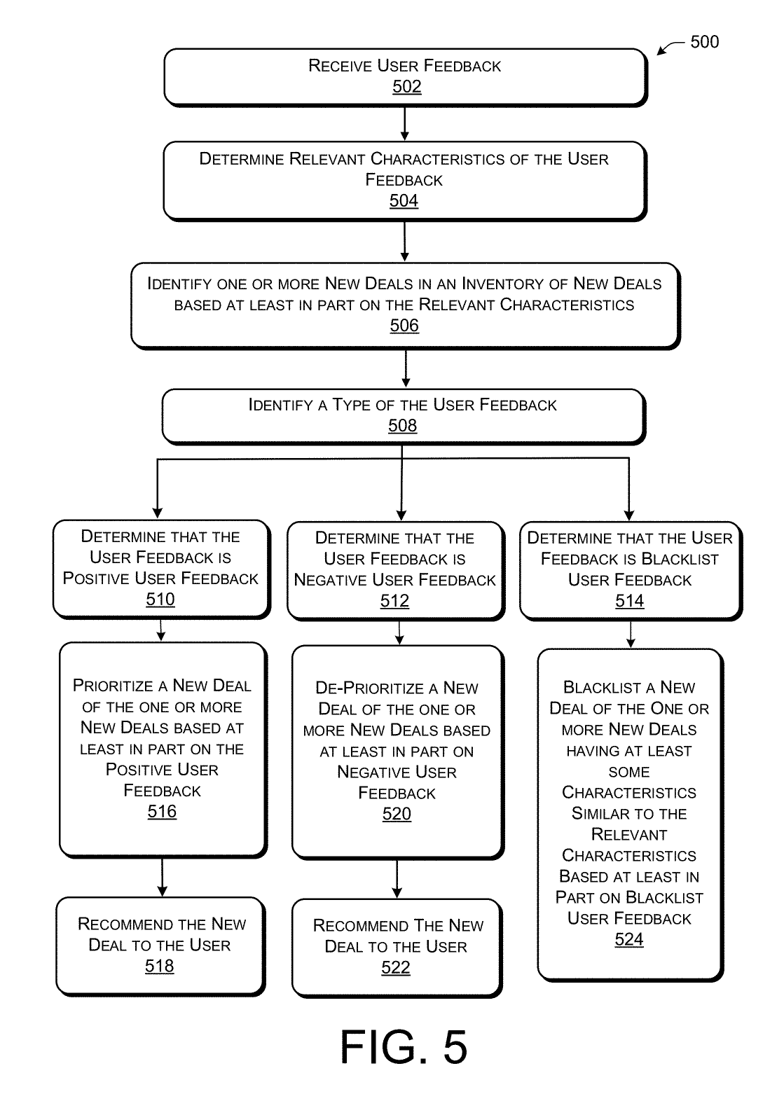

FIG. 5 is a flow diagram illustrating an example process of recommending new deals 136 to consumers (e.g., users 108) based on user feedback. Moreover, the following actions described with respect to FIG. 5 may be performed by the service provider 102 and/or the content server(s) 114.

Block 502 illustrates receiving user feedback. As described above, user-provided feedback may include, but is not limited to, user reviews, user ratings, user responses to surveys/questionnaires, etc., indicating user 108 preferences, interests, likes/dislikes, complaints, etc. A user may provide user feedback via a self-service website, application or browser of a user device 112, customer service, etc.

Block 504 illustrates identifying relevant characteristics of the user feedback. As described above, the user feedback module 124 may determine relevant characteristics of the user feedback (e.g., user 108 preferences, interests, likes/dislikes, complaints, etc.).

Block 506 illustrates identifying one or more new deals 136 in an inventory of new deals 136 based at least in part on the relevant characteristics of the user feedback. As described above, the deal identification module 130 may use the merchant data 208, deal performance data 210, user feedback data 212, and/or portfolio inventory data 214 to identify new deals 136 in an inventory of new deals 136 based at least in part on relevant characteristics of the user feedback.

Block 508 illustrates identifying a type of the user feedback. In at least some embodiments, the user feedback module 124 may determine the type of the user feedback is positive user feedback 510, negative user feedback 512, or blacklist user feedback 514. Positive user feedback 510 may include neutral user feedback. Blacklist user feedback 514 indicates that the user 108 who provided the blacklist user feedback 514 no longer wishes to receive recommendations for deals 134 having the identified characteristics.

Block 516 illustrates, at least partly in response to determining the user feedback is positive user feedback 510, prioritizing a new deal 136 of the one or more new deals 136 based at least in part on the positive user feedback. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214. In at least some embodiments, when a user provides positive user feedback, the prioritization module 132 may prioritize new deals 136 from the merchants 106, categories, subcategories, etc. identified in the positive user feedback. Block 518 illustrates recommending the new deal 136 to the user 108 as described above.

Block 520 illustrates, at least partly in response to determining the user feedback is negative user feedback 512, de-prioritizing a new deal 136 of the one or more new deals 136 based at least in part on the negative user feedback. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214. In some embodiments, the prioritization module 132 may de-prioritize new deals 136 based in part on the user feedback. For instance, when a user provides negative user feedback, the prioritization module 132 may de-prioritize new deals 136 from the merchants 106, categories, subcategories, etc. identified in the negative user feedback. De-prioritizing the new deals 136 may prevent a user 108 from receiving recommendations for new deals 136 having at least some of the relevant characteristics, or may greatly decrease the frequency by which a user 108 receives such recommendations. In at least some embodiments, the service provider 102 may continue to recommend deals 134 having at least some of the relevant characteristics. In that case, block 522 illustrates recommending the new deal 136 to the user 108 as described above. In other embodiments, the service provider 102 may recommend a new deal 136 having characteristics different from those identified in the negative user feedback.

Block 524 illustrates, in response to determining the user feedback is blacklist user feedback 514, blacklisting a new deal 136 of the one or more new deals 136 having at least some characteristics similar to the relevant characteristics based at least in part on the blacklist user feedback. Blacklisting a new deal 136 may prevent a user 108 from receiving recommendations for new deals 136 having at least some of the relevant characteristics. Additionally, the service provider 102 may recommend a new deal 136 having characteristics different from those identified in the blacklist user feedback.

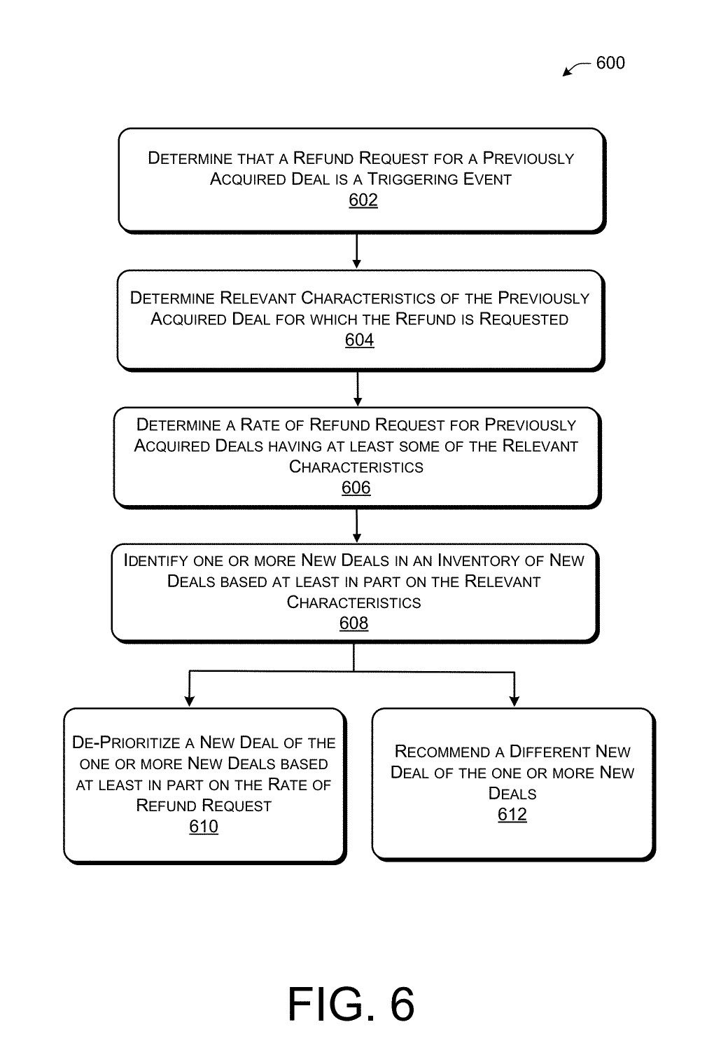

FIG. 6 is a flow diagram illustrating an example process of recommending new deals 136 to consumers (e.g., users 108) based on a refund request of a previously acquired deal 134. Moreover, the following actions described with respect to FIG. 6 may be performed by the service provider 102 and/or the content server(s) 114.

Block 602 illustrates determining a refund request for a previously acquired deal 134 to be a triggering event. As described above, a user 108 may request a refund at a self-service website, an application or browser on a user device 112, or via customer service. Upon completing the refund request, the user 108 may receive a refund at the time the refund request is completed, such as, for example immediate deposit into a user's 108 electronic wallet or a refund directly back to a card used to acquire the deal 134. In at least some embodiments, a user 108 may be prompted to provide user feedback at the time of the refund request.

Block 604 illustrates determining relevant characteristics of the previously acquired deal 134 for which the refund is requested. In some embodiments, when the user provides user feedback at the time of the refund request, relevant characteristics of the user feedback may also be determined. As described above, the deal performance module 122, user feedback module 124, and/or portfolio inventory module 126 may determine relevant characteristics of the previously acquired deals 134 and/or user feedback.

Block 606 illustrates determining a rate of refund request for previously acquired deals 134 having at least some of the relevant characteristics of the previously acquired deals 134 and/or the user feedback. In some embodiments, the portfolio inventory module 126 may determine a rate of refund request based at least in part on the frequency a user 108 requests a refund for previously acquired deals 134 having at least some similar characteristics.

Block 608 illustrates identifying one or more new deals 136 in an inventory of new deals 136 based at least in part on the relevant characteristics. As described above, the deal identification module 130 may use the merchant data 208, deal performance data 210, user feedback data 212, and/or portfolio inventory data 214 to identify new deals 136 in an inventory of new deals 136 based at least in part on the new deals 136 having characteristics similar to those identified in the previously acquired deal 134 for which the user 108 requested the refund and/or the user feedback.

Block 610 illustrates de-prioritizing a new deal 136 of the one or more new deals 136 based at least in part on the rate that the user 108 requests refunds for previously acquired deals 134 having at least some of the relevant characteristics. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214. The prioritization module 132 may also prioritize new deals 136 based at least in part on the predetermined rates of refund requests. In at least some embodiments, when a user 108 repeatedly requests refunds for previously acquired deals 134 from a particular merchant 106, category, subcategory, price, and/or geographic location, the deal performance module 122 and/or portfolio inventory module 126 may recognize such behavior as a user 108 preference. Accordingly, the deal performance module 122 and/or portfolio inventory module 126 may de-prioritize new deals 136 having at least a same merchant 106, category, subcategory, price, and/or geographic location. In at least some embodiments, de-prioritizing new deals 136 may comprise decreasing the frequency of recommendations for new deals 136 having at least some of the relevant characteristics, or blacklisting new deals 136 having at least some of the relevant characteristics.

Block 612 illustrates recommending a different new deal 136 of the one or more new deals 136. In some embodiments, the service provider 102, via the deal recommendation module 128 may recommend a new deal 136 to a user 108 having characteristics different from those identified in the previously acquired deal 134 for which the user 108 requested the refund. The deal recommendation module 128 may recommend a new deal 136 equal to or less than the cost of the previously acquired deal 134 for which the user 108 requested the refund. Alternatively, the new deal 136 may be a highly discounted new deal 136 that may have at least some of the relevant characteristics, depending on user feedback received by the user feedback module 124.

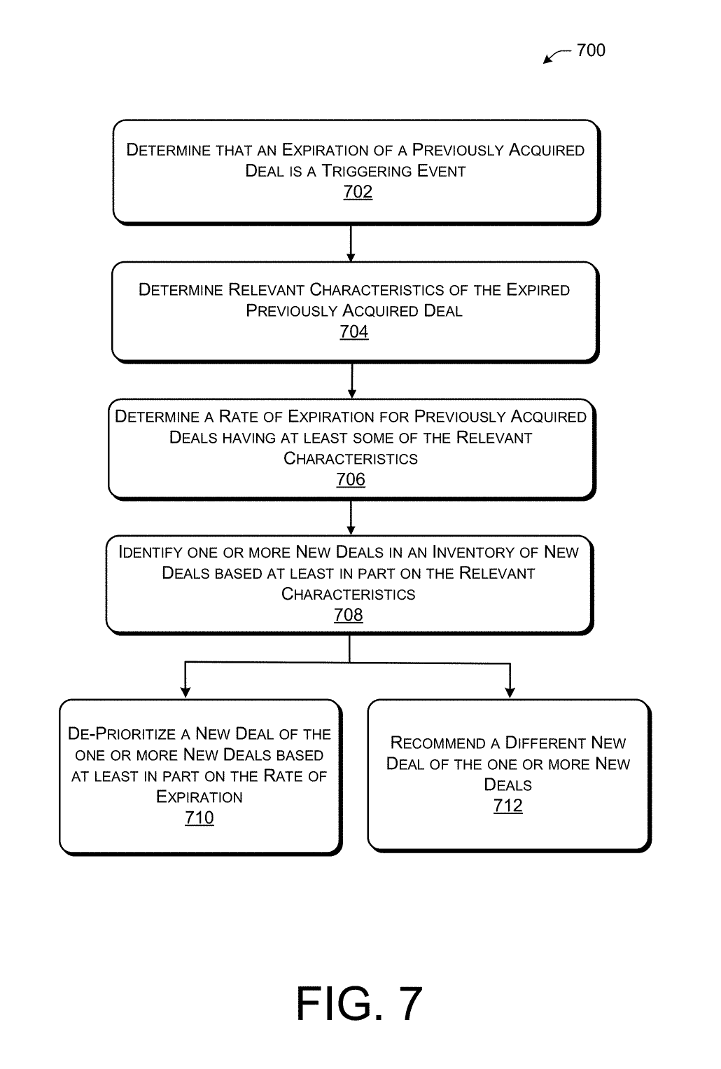

FIG. 7 is a flow diagram illustrating an example process of recommending new deals 136 to consumers (e.g., users 108) based on an expiration of a previously acquired deal 134. Moreover, the following actions described with respect to FIG. 7 may be performed by the service provider 102 and/or the content server(s) 114.

Block 702 illustrates determining an expiration of a previously acquired deal 134 to be a triggering event. As described above, a user 108 may allow a previously purchased deal 134 to expire if the user 108 fails to redeem the previously acquired deal 134 prior to a date provided by merchant 106 parameters.

Block 704 illustrates determining relevant characteristics of the expired previously acquired deal 134. As described above, the deal performance module 122, user feedback module 124, and/or portfolio inventory module 126 may determine relevant characteristics of previously acquired deals 134.

Block 706 illustrates determining a rate of expiration for previously acquired deals 134 having at least some of the relevant characteristics. In some embodiments, the portfolio inventory module 126 may determine a rate of expiration based at least in part on a frequency that a user 108 allows previously acquired deals 134 having similar characteristics to expire.

Block 708 illustrates identifying one or more new deals 136 in an inventory of new deals 136 based at least in part on the relevant characteristics. As described above, the deal identification module 130 may use the merchant data 208, deal performance data 210, user feedback data 212, and/or portfolio inventory data 214 to identify new deals 136 in an inventory of new deals 136 based at least in part on the new deals 136 having at least some characteristics similar to those identified in the expired previously acquired deal 134.

Block 710 illustrates de-prioritizing a new deal 136 of the one or more new deals 136 based at least in part on the rate of expiration. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214. The prioritization module 132 may also prioritize new deals 136 based at least in part on the relative rates of expiration. In at least some embodiments, when a user repeatedly allows previously acquired deals 134 from a particular merchant 106, category, subcategory, price, and/or geographic location to expire, the deal performance module 122 and/or the portfolio inventory module 126 may recognize such behavior as a user 108 preference and may de-prioritize new deals 136 having at least some of the same relevant characteristics.

Block 712 illustrates recommending a different new deal 136 of the one or more new deals 136. In some embodiments, the service provider 102, via the deal recommendation module 128 may recommend a new deal 136 having characteristics different from those identified in the expired previously acquired deal 134. Alternatively, the deal recommendation module 128 may recommend a new deal 136 having at least some of the relevant characteristics, particularly if the rate of expiration for deals 134 having at least some of the relevant characteristics is below a predetermined threshold.

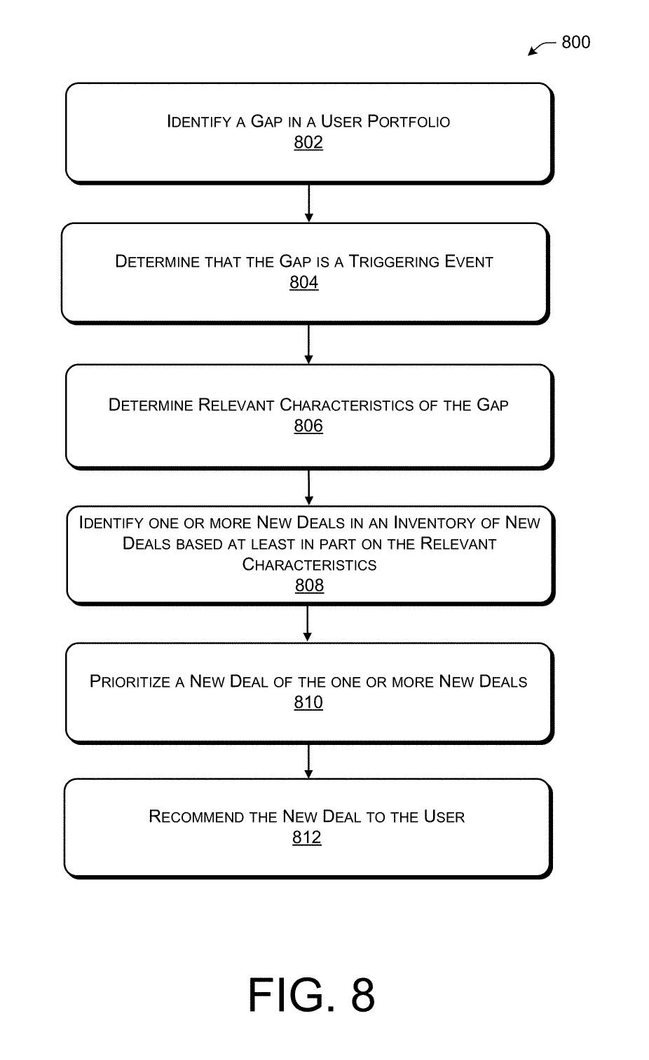

FIG. 8 is a flow diagram illustrating an example process of recommending new deals 136 to consumers (e.g., users 108) based on an identified gap in a user's 108 portfolio of previously acquired deals 134. Moreover, the following actions described with respect to FIG. 8 may be performed by the service provider 102 and/or the content server(s) 114.

Block 802 illustrates identifying a gap in a user's 108 portfolio. As described above, the portfolio inventory module 126 may identify gaps in a user's 108 portfolio such that the user's 108 portfolio lacks deals 134 relevant to or corresponding with some or all of a user's 108 preferences.

Block 804 illustrates determining the gap in the user's 108 portfolio to be a triggering event.

Block 806 illustrates determining relevant characteristics of the gap. As described above, the portfolio inventory module 126 may determine which of the user's 108 preferences are not represented by one or more previously purchased deals 134 in a user's 108 portfolio. The portfolio inventory module 126 may determine such preferences to be relevant characteristics of the gap.

Block 808 illustrates identifying one or more new deals 136 in an inventory of new deals 136 based at least in part on the relevant characteristics of the gap. As described above, the deal identification module 130 may use the merchant data 208, deal performance data 210, user feedback data 212, and/or portfolio inventory data 214 to identify new deals 136 in an inventory of new deals 136 based at least in part on the new deals 136 having at least some characteristics similar to those deals 134 that are not presently included in the user's 108 portfolio.

Block 810 illustrates prioritizing a new deal 136 of the one or more new deals 136 for recommendation to the user 108. As described above, in various embodiments, when the deal identification module 130 identifies more than one new deal 136 for recommendation to a user 108, the prioritization module 132 may prioritize the new deals 136 based at least in part on the merchant data 208, deal performance data 210, user feedback data 212, and/or portfolio inventory data 214.

Block 812 illustrates recommending the new deal 136 to the user 108.

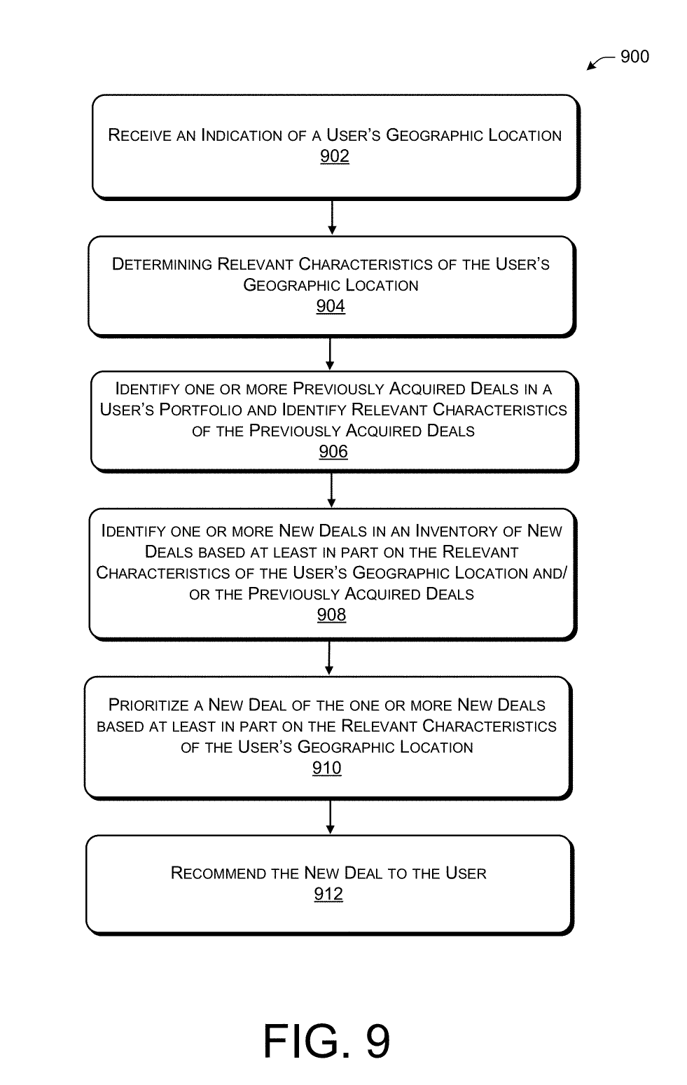

FIG. 9 is a flow diagram illustrating an example process of recommending new deals 136 to consumers (e.g., users 108) based on an indication of a user's 108 geographic location. Moreover, the following actions described with respect to FIG. 9 may be performed by the service provider 102 and/or the content server(s) 114.

Block 902 illustrates receiving an indication of a user's 108 geographic location. The service provider 102 may identify the indication as a triggering event. The indication of the user's 108 geographic location could be via identification of a location where a user 108 redeems a previously acquired deal 134, a user 108 check-in, a geo-tag, a geographic location derived from a user device 112 or an application residing on the user device 112, etc.

Block 904 illustrates determining relevant characteristics of the user's 108 geographic location. For example, the service provider 102 may identify the geographic location where a user 108 redeems a previously acquired deal 134, where a user 108 checks-in, where the user 108 is located based on a geo-tag, etc.

Block 906 illustrates identifying one or more previously acquired deals 134 in a user's 108 portfolio and determining relevant characteristics of the previously acquired deals 134 in the user's 108 portfolio. As described above, the deal performance module 122, user feedback module 124, and/or portfolio inventory module 126 may determine relevant characteristics of the previously acquired deals 134.

Block 908 illustrates identifying one or more new deals 136 in an inventory of new deals 136 based at least in part on the relevant characteristics of the user's 108 geographic location and/or the previously acquired deals 134. As described above, the deal identification module 130 may use the merchant data 208, deal performance data 210, the user feedback data 212, and/or the portfolio inventory data 214 to identify new deals 136 in an inventory of new deals 136 based at least in part on new deals 136 having at least some characteristics similar to those identified as relevant characteristics of the user's 108 geographic location and/or the previously acquired deals 134.

Block 910 illustrates prioritizing a new deal 136 of the one or more new deals 136 for recommendation to the user 108 based at least in part on the relevant characteristics of the user's 108 geographic location.

Block 912 illustrates recommending the new deal 136 to the user 108.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A method comprising:
storing, by one or more computing devices, a portfolio of previously acquired deals associated with a user;
identifying, by the one or more computing devices, purchasing preferences associated with the user based on prior activity relating to the previously acquired deals;
maintaining, by the one or more computing devices, a current inventory of deals associated with the user yet to be redeemed;
comparing, by the one or more computing devices, the purchasing preferences with the current inventory to identify a gap for the user, the gap corresponding to a purchasing preference without a corresponding deal yet to be redeemed in the current inventory;
determining, by the one or more computing devices and based on input received across a computing network, that a triggering event associated with a first deal in the current inventory has occurred;
identifying, by the one or more computing devices, a type of the triggering event. the type of the triggering event including at least one of a redemption of the first deal, an expiration of the first deal, or a refund request of the first deal;
determining, by the one or more computing devices, at least one relevant characteristic of the first deal, the at least one relevant characteristic including at least one of a merchant associated with the first deal, a category of products or services associated with the first deal, a subcategory of products or services associated with the first deal, a price paid for the first deal, or a geographic location associated with the first deal;
determining, by the one or more computing devices, a second deal based at least in part on the type of the triggering event, the at least one relevant characteristic, and the gap; and
sending, by at least one of the one or more computing devices, the second deal to an electronic device of the user across the computing network.

2. The method of claim 1, wherein sending the second deal to the user occurs concurrently with an occurrence of the triggering event.

3. The method of claim 1, further comprising:
determining a rate of occurrence for the triggering event for previously acquired deals having the at least one relevant characteristic; and
prioritizing, from a plurality of new deals, the second deal based at least in part on the rate of occurrence.

4-12. (canceled)

13. One or more non-transitory computer-readable media having computer executable instructions that, when executed by one or more processors of one or more computing devices, cause the one or more processors to perform operations comprising:
storing, by the one or more computing devices, a portfolio of previously acquired deals associated with a user;
identifying, by the one or more computing devices, purchasing preferences associated with the user based on prior activity relating to the previously acquired deals;
maintaining, by the one or more computing devices, a current inventory of deals associated with the user yet to be redeemed;
comparing, by the one or more computing devices, the purchasing preferences with the current inventory to identify a gap for the user, the gap corresponding to a purchasing preference without a corresponding deal yet to be redeemed in the current inventory;
determining, based on input received across a computing network, that at least one triggering event associated with a first deal in the current inventory has occurred;
identifying, by the one or more computing devices, a type of the at least one triggering event, the type of the at least one triggering event including at least one of a redemption of the first deal, an expiration of the first deal, or a refund request of the first deal;
determining, by the one or more computing devices, at least one relevant characteristic of the first deal, the at least one relevant characteristic including at least one of a merchant associated with the first deal, a category of products or services associated with the first deal, a subcategory of products or services associated with the first deal, a price paid for the first deal, or a geographic location associated with the first deal;
determining, by the one or more computing devices, a second deal based at least in part on the type of the triggering event, the at least one relevant characteristic, and the gap; and
sending, by at least one of the one or more computing devices, the second deal to an electronic device of the user across the computing network.

14. The one or more non-transitory computer-readable media of claim 13, wherein sending the second deal to the user occurs concurrently with an occurrence of the at least one triggering event.

15. (canceled)

16. (canceled)

17. The one or more non-transitory computer-readable media of claim 13, wherein the operations further comprise:
determining a rate of occurrence for the type of the at least one triggering event for previous acquired deals having the at least one relevant characteristic; and
prioritizing, from one or more new deals, the second deal for sending to the user based at least in part on the rate of occurrence.

18. The one or more non-transitory computer-readable media of claim 13, wherein the operations further comprise:
determining relevant characteristics of the gap, the relevant characteristics including at least one of a merchant associated with the gap, a category of products or services associated with the gap, a subcategory of products or services associated with the gap, a price point associated with the gap, or a geographic location associated with the gap;
wherein determining the second deal comprises:
identifying one or more new deals having at least some of the relevant characteristics of the gap; and
prioritizing, from the one or more new deals, the second deal for sending to the user.

19. The one or more non-transitory computer-readable media of claim 13, wherein determining the second deal is further based at least in part on a type of user feedback, the type of user feedback including positive user feedback, negative user feedback, or blacklist user feedback.

20. The one or more non-transitory computer-readable media of claim 19, wherein the operations further comprise:
at least partly in response to determining that the user feedback is positive user feedback, prioritizing a new deal in determining the second deal, the new deal including at least some relevant characteristics that are common with the at least one relevant characteristic of the first deal or characteristics of the user feedback;
at least partly in response to determining that the user feedback is negative user feedback, de-prioritizing the new deal in determining the second deal, the new deal including at least some relevant characteristics that are common with the at least one relevant characteristic of the first deal or the characteristics of the user feedback; and
at least partly in response to determining that the user feedback is blacklist user feedback, blacklisting the new deal including at least some relevant characteristics that are common with the at least one relevant characteristic of the first deal and the characteristics of the user feedback such that the new deal that is blacklisted is not provided to the user.

21. A system comprising:
one or more processors within one or more computing devices; and
one or more computer-readable media storing instructions that, when executed by the one or more processors, cause the one or more processors to perform operations comprising:
storing, by the one or more computing devices, a portfolio of previously acquired deals associated with a user;
identifying, by the one or more computing devices, purchasing preferences associated with the user based on prior activity relating to the previously acquired deals;
maintaining, by the one or more computing devices, a current inventory of deals associated with the user yet to be redeemed;
comparing, by the one or more computing devices, the purchasing preferences with the current inventory to identify a gap for the user, the gap corresponding to a purchasing preference without a corresponding deal yet to be redeemed in the current inventory;
determining, based on input received across a computing network, that a triggering event associated with a first deal in the current inventory has occurred;
identifying, by the one or more computing devices, a type of the triggering event, the type of the triggering event including at least one of a redemption of the first deal, an expiration of the first deal, or a refund request of the first deal;
determining, by the one or more computing devices, at least one relevant characteristic of the first deal, the at least one relevant characteristic including at least one of a merchant associated with the first deal, a category of products or services associated with the first deal, a subcategory of products or services associated with the first deal, a price paid for the first deal, or a geographic location associated with the first deal;
determining, by the one or more computing devices, a second deal based at least in part on the type of the triggering event, the at least one relevant characteristic, and the gap; and
sending, by at least one of the one or more computing devices, the second deal to an electronic device of the user across the computing network.

22. The system of claim 21, wherein sending the second deal to the user occurs concurrently with an occurrence of the triggering event.

23. (canceled)

24. (canceled)

25. The system of claim 21, the operations further comprising:
determining a rate of occurrence for the type of the triggering event for previously acquired deals having the at least one relevant characteristic; and
prioritizing, from one or more new deals, the second deal for sending to the user based at least in part on the rate of occurrence.

26. The system of claim 21, wherein the operations further comprise:
determining second relevant characteristics of the gap, the second relevant characteristics including at least one of a merchant associated with the gap, a category of products or services associated with the gap, a subcategory of products or services associated with the gap, a price point associated with the gap, or a geographic location associated with the gap;
wherein determining the second deal comprises:
identifying one or more new deals having at least some of the relevant characteristics of the gap; and
prioritizing, from the one or more new deals, the second deal for sending to the user.

27. The system of claim 21, wherein
determining the second deal is further based at least in part on a type of user feedback, the type of user feedback including positive user feedback, negative user feedback, or blacklist user feedback.

28. The system of claim 27, the operations further comprising, at least partly in response to determining that the user feedback is positive user feedback, prioritizing a new deal in determining the second deal, the new deal including at least some relevant characteristics that are common with the at least one relevant characteristic of the first deal or characteristics of the user feedback.

29. The system of claim 27, the operations further comprising, at least partly in response to determining that the user feedback is negative user feedback, de-prioritizing a new deal in determining the second deal, the new deal including at least some relevant characteristics that are common with the at least one relevant characteristic of the first deal or the characteristics of the user feedback.

30. The method of claim 1, wherein sending the second deal to an electronic device of the user comprises adding the second deal to a queue within an application of the at least one of the one or more computing devices, the second deal to be presented to the user upon a subsequent interaction with the application.

31. The one or more non-transitory computer-readable media of claim 13, wherein sending the second deal to an electronic device of the user comprises adding the second deal to a queue within an application of the at least one of the one or more computing devices, the second deal to be presented to the user upon a subsequent interaction with the application.

32. The system of claim 21, wherein sending the second deal to an electronic device of the user comprises adding the second deal to a queue within an application of the at least one of the one or more computing devices, the second deal to be presented to the user upon a subsequent interaction with the application.
